(19) United States
(12) Patent Application Publication
(10) Pub. No.: US 2019/0029911 A1
(43) Pub. Date: Jan. 31, 2019

(54) MAGNETIC MOBILITY AID

(71) Applicant: ADMIRAL KIRK SUDDUTH, MANASSAS, VA (US)

(72) Inventor: ADMIRAL KIRK SUDDUTH, MANASSAS, VA (US)

(21) Appl. No.: 15/662,283

(22) Filed: Jul. 28, 2017

(51) Int. Cl. A61H 3/00; A45B 3/00; A45B 9/04; B25J 1/04; B25J 15/06; H01F 7/06

(52) U.S. Cl. CPC A61H 3/00; A45B 3/00; A45B 9/04; A61H 2003/0222; B25J 15/0608; H01F 7/06; B25J 1/04

(57) ABSTRACT

A magnetic Retrieval Mobility Aid is featured. The Mobility Aid is comprised generally of an extended body, which is comprised, generally, of an extended body, a support tip at the bottom of the extended body and a handle portion at the upper end. A magnet, magnetic substance or suitable magnetic device is provided at or near the end of the support tip, and another. magnet may also be provided within the handle portion. A user can simply place the support tip on or immediately above a metallic item, and the item magnetically attaches to the support tip, thereby allowing more convenient retrieval of the item.

### TECHNICAL FIELD OF THE INVENTION

The present invention relates to the general art of mobility aids and more specifically to an apparatus for increasing convenience for users with mobility issues.

### BACKGROUND OF THE INVENTION

For persons with mobility issues, such as, for example, back, knee, neck, hip or leg pain, vertigo, being in a leg cast, amputation, or are in a period of post-surgical recovery or physical therapy, mobility devices such as canes, walking sticks, crutches which provide support to a weakened or injured leg, can be crucial to going about life, and devices that provide such assistance are known in the art. However, the devices can be unhelpful, or even an obstacle, if a user is in a situation in which the user needs to retrieve an item from a low or high place or bend or stoop over, or reach high, to recover commonly carried metallic items, such as keys, keyrings, papers that are clipped or stapled together, or other objects with a metallic ring or clamp. For example, a frequent situation in one in which a user drops their keys, change or other miscellaneous items including the mobility aid itself can be retrieved magnetically.

This happens frequently to many people. For those without mobility issues, they simply pick up the item(s) from the ground and give it no further thought. For a user with mobility issues, such as difficulty bending or stooping though, this can be difficult. Such a user would necessarily need to bend down to retrieve the object(s), which may be hard or even impossible. If this happens when nobody is available to help and the object is necessary (As example, if the user drops their keys in a parking lot late at night), this can move beyond inconvenience and become a serious problem.

Even in more controlled situations, access can be very inconvenient. If the user is in a home or office, items on a shelf or other locations above or below easy hand reach can become difficult to get to.

What is needed is a system that addresses this issue, providing a way to pick up at least important metallic objects, which are frequently dropped, such as keys and coins

### SUMMARY

A Magnetic Mobility aid is disclosed herein

A magnetic Retrieval Mobility Aid is shown and featured. The Mobility Aid is comprised generally of an extended body, which typically is shaped at a top end to support a user. The extended body is comprised, generally, of a handle portion at an upper end and a support portion.

A magnet, magnetic substance or suitable magnetic device is provided within the support portion, the handle portion, or both. The magnet or magnetic device can be comprised of a magnet or magnets, a magnetized metal or other suitable substances or combination of substances capable of magnetically attracting metallic items.

The extended body may be solid, hollow, or even have a telescoping collapsing arrangement to save space.

A magnet is provided and placed at or near the end of the support portion. The support portion can have a hollow space for the magnet or as discussed, the entire extended body may be hollow or partially hollow to accommodate the magnet.

The support portion can be further comprised of a support tip. The support tip can fit over the end of the extended body.

In another embodiment, the magnet is not provided and the support tip is of a magnetic material itself.

The handle portion is further comprised of a handle that can fit over the upper end of the extended body. A magnet can be provided within the handle portion of the mobility aid.

In another embodiment, the magnet is not provided and the handle is of a magnetic material itself.

When a user is using the mobility aid, the user simply places the support tip on or immediately above a metallic item, and the item magnetically attaches to the support tip. The user can then lift the mobility device and recover the metallic item from the support tip.

Alternatively, another magnet may also be provided in the handle portion. The user can then, similarly, use the end of the handle portion to magnetically attach and pick up a metallic item.

A magnetized handle can be provided. The magnetized handle, rather than containing a magnet, can be itself comprised of a magnetic material and can be connected to, or be fitted upon, the handle portion.

Further, a magnetized support tip can be provided. The magnetized support tip, rather than containing a magnet, can be itself comprised of a magnetic material, and can be connected to, or be fitted upon, the support area.

In another embodiment, when the user wishes a portion of the mobility aid to become magnetic, the user makes use of an activating device such as a button or switch. When the user has pushed a button, flipped a switch, or the like, a power source, such as a battery, solar cell, or any suitable type in the art for supplying power, transfers electrical power to one or both of a pair of electrically operated magnets. When the magnet(s) are activated, and the mobility aid becomes magnetized, the user can easily use it to grasp appropriate objects.

Hereby disclosed is a device for remove-ably and magnetically attaching objects to assist in their retrieval.

### BRIEF DESCRIPTION OF THE DRAWINGS

FIG. 1 is a schematic side view of a preferred embodiment of the invention.

FIG. 1a is a schematic front view of the preferred embodiment of FIG. 1.

FIG. 1b is a schematic top plan view of the preferred embodiment of FIG. 1.

FIG. 2 is a schematic side view of a portion of the embodiment of FIG. 1

FIG. 3 is a schematic side view of a portion of the embodiment of FIG. 1.

FIG. 4 is a schematic side view of a portion of an additional embodiment of the invention.

FIG. 5 is a schematic side view of a portion of an additional embodiment of the invention.

FIG. 6 is a schematic side view of another embodiment of the invention, in partial cutaway view.

FIG. 7 is a schematic side view of yet another embodiment of the invention.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference numbers refer to like features throughout this description. Not all numbers appearing in one figure are necessarily present in another.

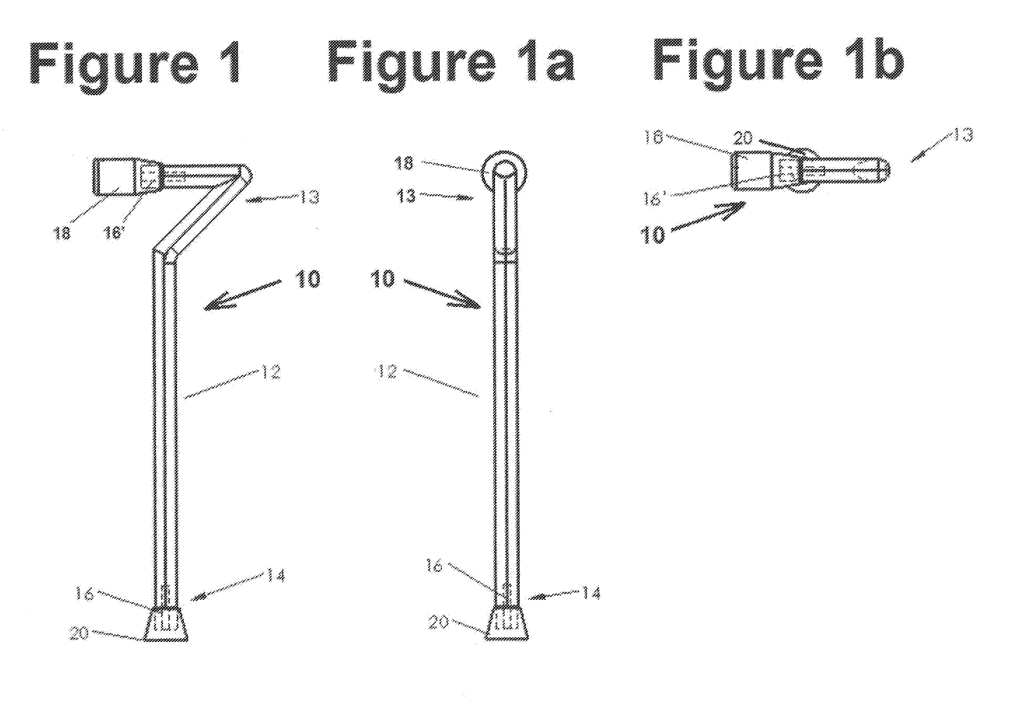

Turning first to FIG. 1, a Magnetic Retrieval Mobility Aid 10 (“Mobility Aid”) is shown and featured. The Mobility Aid is comprised generally comprised, generally, of a handle portion 13 at the upper end, a support portion 14 at the lower end, and an extended body portion 12 between and joining the handle portion 13 and support portion 14. The handle portion 13 typically is shaped at the top end to provide support to a user by providing a place for a user to rest their hand upon to distribute weight. The shape at this end can be, e.g., similar to an inverted or sideways “U” or as in this embodiment, a sideways “V” shape, a straight horizontal bar extending ninety degrees from the extended body 12, or other suitable shape for providing user support. From the top end, the extended body 12 extends downward to the support portion 14 at the bottom of the mobility aid.

A magnet, magnetic substance or suitable magnetic device, 16, 16′ (“magnet”) is provided within the support portion 14, the handle portion 13, or both. Herein, the term “magnet” or “magnetic device” shall be understood to mean any suitable magnetic means in the art such as, e.g., a magnet or magnets, a magnetized metal or other suitable substance(s) or combination of substances with the property of magnetism.

Here, the magnet or magnetic device 16, 16′ can be of any suitable size and shape, and arranged in any suitable configuration.

The extended body 12 and by extension, the mobility aid 10 can be comprised of any suitable material or combination of materials in the art for such devices. This can include, e.g., a metal, wood, plastic or other resin, or other suitable material or combination thereof. The extended body may be solid, hollow, or even have a telescoping collapsing arrangement to save space.

Turning to FIGS. 1a-1b, the mobility aid 10 is shown in, respectively, from the front and from the top

Turning to FIG. 3, the support portion area 14 is shown in greater detail. A magnet 16 is provided and placed at or near the end of the support portion 14. The support portion 14 can have a hollow space for the magnet or as discussed, the entire extended body 12 may be hollow or partially hollow to accommodate the magnet 16.

The support area 14 is shown in this embodiment as a single leg, but may, as seen commonly with mobility aids in the art, be comprised of two or more legs, extending downward from the extended body 12 to the ground for increased stability. The support portion 14, in this embodiment, is further comprised of a support tip 20 The support tip 20 can, as in this embodiment, fit over the end of the extended body 12. The support tip can be comprised of any suitable material in the art such as, e.g., rubber or rubberized material, plastic or other resin, silicone, or silicone gel.

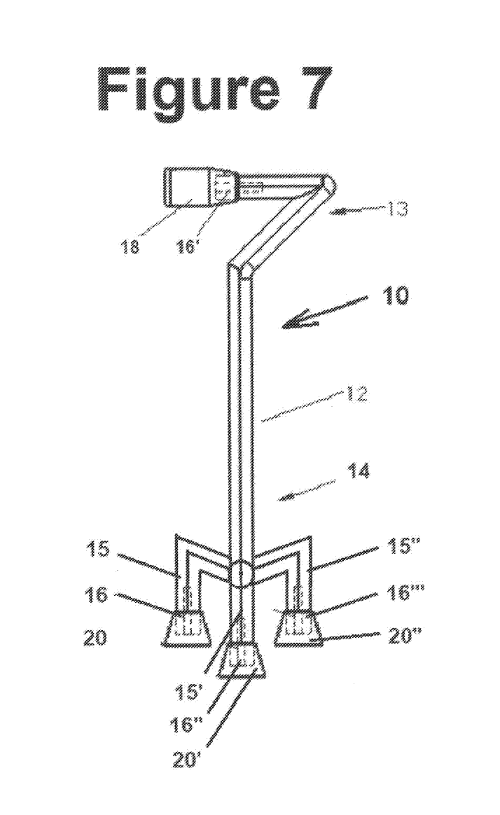

Turning to FIG. 7, an embodiment is shown with three support legs 15, 15′, 15″ Support legs with corresponding magnets 16, 16″, 16′″ and support tips 20, 20′, 20″

In another embodiment, the magnet 16 is not provided and the support tip 20 is of a magnetic material itself.

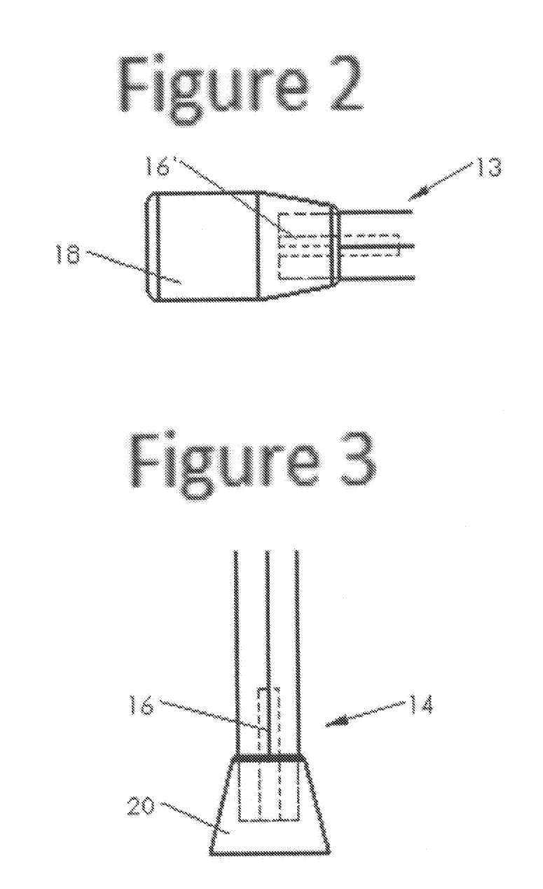

Turning to FIG. 2, the handle portion 13 is shown, in greater detail. The handle portion 13, in this embodiment, is further comprised of a handle 18 The handle 18 can, as in this embodiment, fit over the upper end of the extended body 12. The handle 18 can be comprised of any suitable material in the art such as, e.g., rubber or rubberized material, plastic or other resin, silicone, or silicone gel. A magnet 16′ can be provided within the handle portion 13 of the mobility aid 10.

In another embodiment, the magnet 16 is not provided and the handle 18 is of a magnetic material itself.

In operation, the magnet 16 is provided within or at the support tip 20 as described. When a user is using the mobility aid 10, if the user needs to reach a metallic item, the user simply places the support tip 20 on or immediately above the metallic item, the item magnetically attached to the support tip 20. The user can then lift the mobility device 10 and recover the metallic item from the support tip 20.

Alternatively, another magnet 16′ may also be provided in the handle portion 13. The user can then, similarly, use the end of the handle portion 13 to magnetically attach and pick up a metallic item.

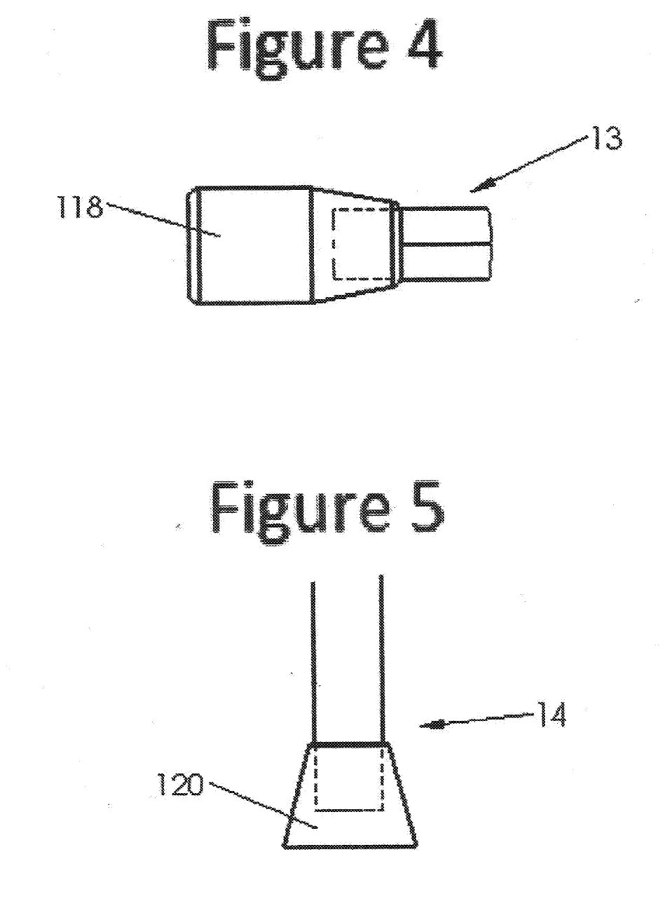

Turning to FIG. 4, another embodiment is shown in which a magnetized handle 118 is provided. The magnetized handle 118, rather than containing a magnet, can be itself comprised of a magnetic material (as referred to previously) and can be connected to, or be fitted upon, the handle portion 13.

Turning to FIG. 5, a magnetized support tip 120 is similarly provided. The magnetized support tip 120, rather than containing a magnet, can be itself comprised of a magnetic material (as referred to previously, and as in the description of the magnetic handle of FIG. 4), and can be connected to, or be fitted upon, the support area 14.

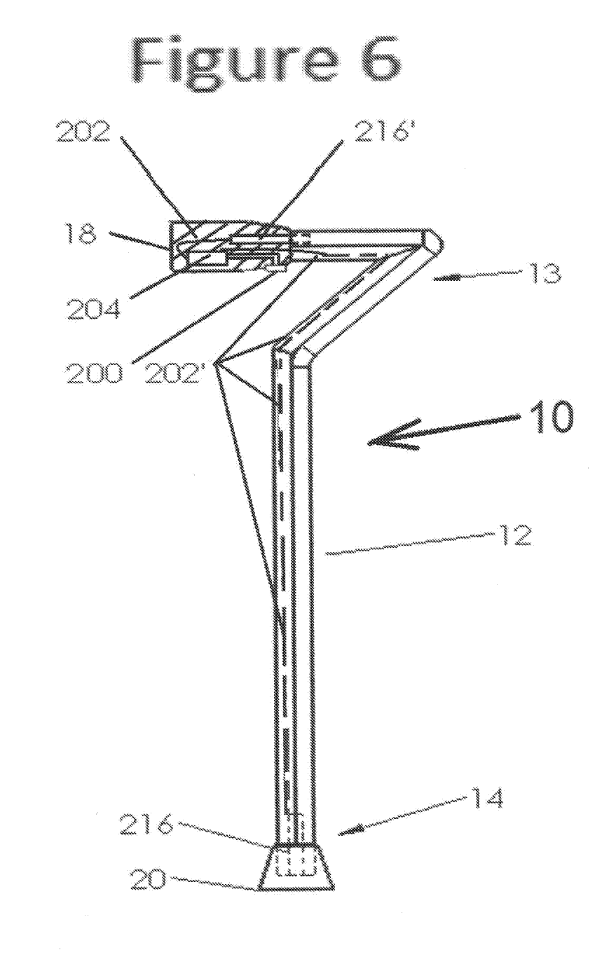

Turning to FIG. 6, another possible embodiment of the inventive concept is shown. The area of the handle 18 is shown in cutaway format to more easily view the inner magnetic apparatus. In this embodiment, the user can control when the mobility aid 10 has magnetic properties. When the user wishes a portion, such as the respective support portion 14 and/or handle portion 13, of the mobility aid 10 to become magnetic (e.g., when a user has dropped keys or has to retrieve a metallic object), the user makes use of an activating device 200 which can be any known in the art such as, for example, a button or switch. When the user has pushed a button, flipped a switch, or the like, a power source 204, such as a battery, solar cell, or any suitable type in the art for supplying power, transfers electrical power to one or both of a pair of electrically operated magnets 216, 216′ through suitable means such as respective wires 202, 202′.

The respective magnet(s) 216, 216′ are of the type that can become magnetized when an electrical current is introduced, such as an electromagnet. When the magnet(s) 216, 216′ are activated, and the mobility aid 10 becomes magnetized the user can use it to grasp appropriate objects. When the user no longer needs a magnetic mobility aid 10, the user can simply turn off the activation device 200.

It is to be understood that these embodiments demonstrate both portions of the mobility aid 10 magnetized, but the mobility aid 10 can be manufactured such that only the support portion 14, handle portion 13, or both are magnetized, depending upon factors such as cost and user need.

Disclosed herein is a mobility aid for assisting in the retrieval of metallic items for a user, preventing inconvenience or even problems for the user. This device can provide additional independence to a wide range of people with mobility disabilities.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A magnetic retrieval mobility aid comprised of
a handle portion located at the top end of the mobility aid relative to a user,
a support portion at the bottom end of the mobility aid, and
an extended body portion between the handle portion and the support portion and joining the handle portion and the support portion,
at least one magnetized apparatus located at the end of the support portion,
a second magnetized apparatus located at the end of the handle portion,
wherein the handle portion is configured in the general shape of a sideways “U” or a sideways “V” in an orientation relative to longitudinal axis of the support portion,
and wherein the handle portion is further comprised of a handle at the end of the handle portion,
and wherein the end of the handle and handle are in a general orientation that is horizontal relative to the longitudinal axis of the support portion and directly above the support portion,
and wherein each of the magnetized apparatus is comprised of at least one magnet, a portion of magnetized metal or a portion of a substance with the property of magnetism.

2. A magnetic retrieval mobility aid according to claim 1, wherein each respective magnetized apparatus is located within the end of the support portion, the handle portion, or both, and the end of the support portion, the handle portion, or both is configured to accommodate the magnetic apparatus.

3. (canceled)

4. A magnetic retrieval mobility aid according to claim 1, wherein the mobility aid is comprised of a metal, wood, plastic or other resin, or a combination thereof.

5. A magnetic retrieval mobility aid according to claim 1, wherein the extended body portion is solid, hollow, or of a telescoping configuration.

6. A magnetic retrieval mobility aid according to claim 1, further comprising at least one support tip at the bottom end of the support portion, and
wherein each support tip is comprised of a rubber or rubberized material, plastic or other resin, silicone, or silicone gel.

7. A magnetic retrieval mobility aid according to claim 1, wherein the handle is comprised of rubber or rubberized material, a plastic or other resin, a silicone or silicone gel.

8. A magnetic retrieval mobility aid according to claim 1, wherein the support portion at the bottom end of the mobility aid is comprised of two or more legs extending downward from the extended body portion.

9. A magnetic retrieval mobility aid according to claim 8, wherein the two or more legs are each further comprised of a support tip at or proximate to the bottom of each respective leg.

10. A magnetic retrieval mobility aid according to claim 9, wherein each support tip is comprised of a rubber or rubberized material, plastic or other resin, silicone, or silicone gel.

11. A magnetic retrieval mobility aid according to claim 1, wherein the least one magnetized apparatus is comprised of
at least one support tip at the end of the support portion comprised of a magnetized metal or a substance with the property of magnetism,
and wherein the handle is comprised of a magnetized metal or a substance with the property of magnetism.

12. A magnetic retrieval mobility aid according to claim 1, wherein the at least one magnetized apparatus is comprised of an activating device, at least one electrically operated magnet, and a power source capable of transferring electrical power to the at least one electrically operated magnet.

13. A magnetic retrieval mobility aid according to claim 12, wherein the activating device is comprised of a button or switch.

14. A magnetic retrieval mobility aid according to claim 12, wherein the electrically operated magnet is an electromagnet.
